(19) United States
(12) Patent Application Publication
(10) Pub. No.: US 2021/0210753 A1
(43) Pub. Date: Jul. 8, 2021

(54) CARBON COMPOSITE ANODE WITH EX-SITU ELECTRODEPOSITED LITHIUM

(71) Applicant: Lyten, Inc., San Jose, CA (US)

(72) Inventors: Jerzy Gazda, Austin, TX (US); Qianwen Huang, San Jose, CA (US); Anurag Kumar, Sunnyvale, CA (US); Jeffrey Bell, Santa Clara, CA (US); Jesse Baucom, Sunnyvale, CA (US); You Li, Sunnyvale, CA (US); Bruce Lanning, Littleton, CO (US)

(73) Assignee: Lyten, Inc., San Jose, CA (US)

(21) Appl. No.: 17/209,038

(22) Filed: Mar. 22, 2021

Related U.S. Application Data
(63) Continuation-in-part of application No. 16/942,229, filed on Jul. 29, 2020.
Application No. 16/942,229 is a continuation-in-part of application No. 16/785,020, filed on Feb. 7, 2020.
Application No. 16/785,020 is a continuation-in-part of application No. 16/785,076, filed on Feb. 7, 2020.
(60) Provisional application No. 62/942,103, filed on Nov. 30, 2019.
(60) Provisional application No. 62/926,225, filed on Oct. 25, 2019.

(51) Int. Cl. H01M 4/36; H01M 10/0525; H01M 4/04; H01M 4/38; H01M 10/0562; H01M 10/36

(52) U.S. Cl. CPC H01M 4/366; H01M 10/0525; H01M 4/0404; H01M 2004/021; H01M 10/0562; H01M 10/36; H01M 4/382

(57) ABSTRACT

Batteries including an ex-situ electrodeposition of lithium are disclosed. In various implementations, a battery may include a cathode, an anode, and a lithium layer. The anode may be positioned opposite the cathode. The anode may include a first thin film deposited on a current collector. The first thin film may include a first plurality of aggregates decorated with a first plurality of metal nanoparticles and joined together to define a first porous structure having a first conductivity. A second thin film may be deposited on the first thin film and may include a second plurality of aggregates decorated with a second plurality of metal nanoparticles and joined together to define a second porous structure having a second conductivity that is different than the first conductivity. The lithium layer may be deposited on the first and second porous structures and may have a thickness greater than 20 microns.

### CROSS-REFERENCE TO RELATED APPLICATIONS

This Patent Application is a continuation-in-part application and claims priority to U.S. patent application Ser. No. 16/942,229 entitled “CARBON-BASED STRUCTURES FOR INCORPORATION INTO LITHIUM (LI) ION BATTERY ELECTRODES filed on Jul. 29, 2020, which is a continuation-in-part application of and claims priority to U.S. patent application Ser. No. 16/785,020 entitled “3D SELF-ASSEMBLED MULTI-MODAL CARBON BASED PARTICLE” filed on Feb. 7, 2020 and to U.S. patent application Ser. No. 16/785,076 entitled “3D SELF-ASSEMBLED MULTI-MODAL CARBON BASED PARTICLES INTEGRATED INTO A CONTINUOUS FILM LAYER” filed on Feb. 7, 2020, both of which claim priority to U.S. Provisional Patent Application No. 62/942,103 entitled “3D HIERARCHICAL MESOPOROUS CARBON-BASED PARTICLES INTEGRATED INTO A CONTINUOUS ELECTRODE FILM LAYER” filed on Nov. 30, 2019 and to U.S. Provisional Patent Application No. 62/926,225 entitled “3D HIERARCHICAL MESOPOROUS CARBON-BASED PARTICLES INTEGRATED INTO A CONTINUOUS ELECTRODE FILM LAYER” filed on Oct. 25, 2019, all of which are assigned to the assignee hereof. The disclosures of all prior Applications are considered part of and are incorporated by reference in this Patent Application in their respective entireties.

### TECHNICAL FIELD

This disclosure relates generally to batteries, and, more particularly, to lithium-ion batteries that can compensate for operational cycle losses.

### DESCRIPTION OF RELATED ART

Recent developments in batteries allow consumers to use electronic devices in many new applications. However, further improvements in battery technology are desirable.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

One innovative aspect of the subject matter described in this disclosure may be implemented as a battery. The battery may include a cathode, an anode positioned opposite the cathode, and a lithium layer. The anode may include a first thin film deposited on a current collector. The first thin film may include a first plurality of aggregates decorated with a first plurality of metal nanoparticles. The first plurality of aggregates may be joined together to define a first porous structure having a first conductivity. In some implementations, a second thin film may be deposited on the first thin film. The second thin film may include a second plurality of aggregates decorated with a second plurality of metal nanoparticles. The second plurality of aggregates may be joined together to define a second porous structure having a second conductivity that is different than the first conductivity. In some aspects, the first conductivity is greater than the second conductivity. The first and second thin films may have an average thickness between approximately 10 microns and approximately 200 microns. The first thin film may have a different concentration of aggregates than the second thin film. For example, in some instances, the first thin film may have a higher concentration of aggregates than the second thin film.

In some implementations, a third thin film may be deposited on the second thin film. The third thin film may include a third plurality of aggregates joined together to define a third porous structure having a third conductivity that is different than the first and second conductivities.

In various implementations, the lithium layer may be deposited on the first and second porous structures. In some instances, the lithium layer may have a thickness greater than 20 microns. In one implementation, the lithium layer may produce lithium-intercalated graphite (LiC₆) by chemically reacting with any one or more of the first plurality of aggregates or the second plurality of aggregates. In some aspects, at least one of the first porous structure or the second porous structure may include carbon nano-onions (CNOs), flaky graphene, crinkled graphene, graphene grown on carbonaceous materials, graphene grown on graphene, or any combination thereof. The lithium layer may include an excess supply of lithium that may compensate for an operational cycle loss of the battery. In some implementations, the lithium layer may include an elemental lithium electrodeposition. In some aspects, the lithium layer may also include trace quantities of one or more additives from the elemental lithium electrodeposition.

In various implementations, an electrolyte may be contained within the battery and in contact with the anode and the cathode. The electrolyte may transport lithium ions from the anode towards the cathode. In some instances, the electrolyte may contain a carbonate. In other instances, the electrolyte may contain ether. In addition, or in the alternative, an artificial solid electrolyte interphase (A-SEI) may be disposed between the anode and the electrolyte. The A-SEI can be formed on one or both of the first and second pluralities of metal nanoparticles.

In some implementations, the first and second porous structures may be derived from a gaseous species controlled by a plurality of gas-solid reactions under non-equilibrium conditions. The first and second plurality of aggregates may have a percentage of carbon to other elements, except hydrogen, within each respective aggregate of greater than 99%. A median size of the aggregates may be between approximately 0.1 microns and 50 microns. A surface area of the aggregates may be between approximately 10 m²/g and 300 m²/g. The first and second porous structures may have a porosity defined by one or more of a thermal process, a carbon dioxide (CO₂) gas treatment, or a hydrogen gas (H₂) treatment.

The metal nanoparticles may include tin (Sn) or a Li alloy. The first and second pluralities of aggregates may include one or more metal-organic frameworks (MOFs). The first and second pluralities of aggregates may include lithium, calcium, potassium, sodium, cesium, or any combination thereof. Each of the aggregates may have an electrical conductivity greater than 500 Siemens per meter (S/m).

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram showing an example battery, according to some implementations.

FIG. 2 is a diagram showing a single layer of graphene that can be used in the battery of FIG. 1, according to some implementations.

FIG. 3 is a schematic diagram showing a graphene nanoplatelet including several layers of the graphene of FIG. 2, according to some implementations.

FIG. 4 is a schematic diagram showing several graphene nanoplatelets joined together to form an aggregate, according to some implementations.

FIG. 5 is a micrograph showing multiple layers of the graphene-containing materials of FIGS. 2-4, according to some implementations.

FIG. 6 is a micrograph of a carbon-based growth decorated with cobalt that can be used in the battery of FIG. 1, according to some implementations.

FIGS. 7 and 8 are micrographs of various carbon nano-onion (CNO) aggregates, according to some implementations.

FIG. 9 shows graphs depicting performance of lithium-sulfur batteries with coated components, according to some implementations.

FIGS. 10 and 11 show graphs depicting performance of batteries with coated separators, according to some implementations.

FIG. 12 shows an example process for the electrodeposition of lithium on a carbon-silver nanoparticle (NP) composite, according to some implementations.

FIG. 13 is an illustration of ex-situ lithium electrodeposition onto a carbon-metal nanoparticle (NP) for various substrate materials, according to some implementations.

Like reference numbers and designations in the various drawings indicate like elements.

### DETAILED DESCRIPTION

The following description is directed to some example implementations for the purposes of describing innovative aspects of this disclosure. However, a person having ordinary skill in the art will readily recognize that the teachings herein can be applied in a multitude of different ways. The described implementations can be implemented in any type of electrochemical cell, battery, or battery pack, and can be used to compensate for first-cycle battery operational power losses. As such, the disclosed implementations are not to be limited by the examples provided herein, but rather encompass all implementations contemplated by the attached claims. Additionally, well-known elements of the disclosure will not be described in detail or will be omitted so as not to obscure the relevant details of the disclosure.

Batteries typically include several electrochemical cells, which can be connected to each other to provide electric power to a wide variety of devices such as (but not limited to) mobile phones, laptops, electric vehicles (EVs), factories, and buildings. Certain types of batteries, such as lithium-ion or lithium-sulfur batteries, may experience capacity loss or capacity fading during initial operation. This may be referred to as a “first-cycle loss.” For example, in a new or “fresh” battery, lithium ions flow freely from the anode to the cathode during a battery discharge cycle, thereby allowing the battery to power a load. During a battery charge cycle, the lithium ions are forced to migrate from the cathode to the anode, where they can be stored for subsequent use. Unfortunately, repeatedly charging and discharging the battery can wear out the cathode, which in turn may reduce the energy storage capacity of the battery. For example, the capacity loss of lithium-ion batteries after 500 consecutive charge and discharge cycles may vary from 12.4% to 24.1%, which translates to an average capacity loss per cycle of between 0.025 and 0.048%. Moreover, anodes containing silicon or metallic lithium may lose significant amounts of their specific capacity (such as between 5 and 30%) during formation of a solid-electrolyte interphase and/or due to side reactions during battery formation and early cycling.

The first cycle capacity losses, as well as subsequent cycle capacity losses, may occur due to stress factors such as the ambient temperature, the discharge C-rate, and the state of charge (SOC) of the battery. As a result, there is a need to reduce such first cycle capacity losses (and the subsequent cycle capacity losses) to increase performance and extend the usable lifespan of the battery.

Various aspects of the subject matter disclosed herein relate to batteries with carbon scaffolded composite electrodes that use electrodeposited alkaline metals, such as lithium, as an active material. In accordance with various implementations of the subject matter disclosed herein, a battery, such as a lithium-ion or a lithium-sulfur battery, may include a cathode, an anode positioned opposite the cathode, and a lithium layer. The anode may include a first thin film deposited on a substrate, such as a current collector, and a second thin film deposited on the first thin film. The first and second thin films may have first and second concentration levels of aggregates, respectively, and may have first and second electrical conductivities, respectively. In some instances, the first concentration level of aggregates in the first thin film may be greater than the second concentration level of aggregates in the second thin film, for example, such that the first thin film has a higher electrical conductivity than the second thin film. Some of the aggregates within each thin film may join together to form first and second porous structures that collectively define a host structure having a plurality of active sites to receive an electrodeposition of lithium.

In some aspects, lithium may be conformally deposited onto the active sites of exposed carbon surfaces of the host structure by ex-situ electrodeposition to form the lithium layer. The lithium layer may have a thickness greater than approximately 5 microns. The lithium layer may form lithium-intercalated graphite (LiC₆) by chemically reacting with available carbon provided by the aggregates in one or both of the first or second thin films. In some aspects, the aggregates may include carbon nano-onions (CNOs), flaky graphene, crinkled graphene, graphene grown on carbonaceous materials, graphene grown on graphene, decorated carbonaceous materials, or any combination thereof. These materials may strengthen the host structure and/or may be tailored to various battery end use applications. For example, first materials having a relatively high exposed surface area per volume, such as crinkled graphene or graphene grown on graphene, may be used in high energy density applications, such as electric vehicles (EVs) or municipal electric power grid storage areas. Conversely, second materials having a relatively low exposed surface area per volume, which typically have simpler structures than the first materials, may be used in less demanding application areas, such as consumer electronics.

In one implementation, the lithium layer is electrodeposited ex-situ in a position separate from an electrochemical cell prior to inclusion of the anode. The ex-situ electrodeposition of lithium onto the exposed carbon surfaces of the host structure may provide an excess supply of lithium that can be used to reduce or mitigate first-cycle battery operational losses. In some instances, the lithium layer may supply all of the lithium required for operation of a given electrochemical cell at high energy output levels.

Particular implementations of the subject matter described in this disclosure can be implemented to realize one or more potential advantages. In some implementations, the host structure disclosed herein can reduce or mitigate operational losses caused by first and subsequent battery charge and discharge cycles. In some implementations, the thickness of the electrodeposited lithium layer may be adjusted based on various user needs or requirements. Metals other than lithium such as (but not limited to) calcium, potassium, sodium, or cesium may also be electrodeposited onto the exposed carbon surfaces of the host structure to form metal-carbon compounds or complexes. As a result, these other non-lithium metals may provide electroactive materials that can increase battery cell performance and longevity. As described below, the pre-lithiation techniques disclosed herein can reduce or mitigate first-cycle capacity losses of batteries such as (but not limited to) lithium-ion batteries and lithium-sulfur batteries.

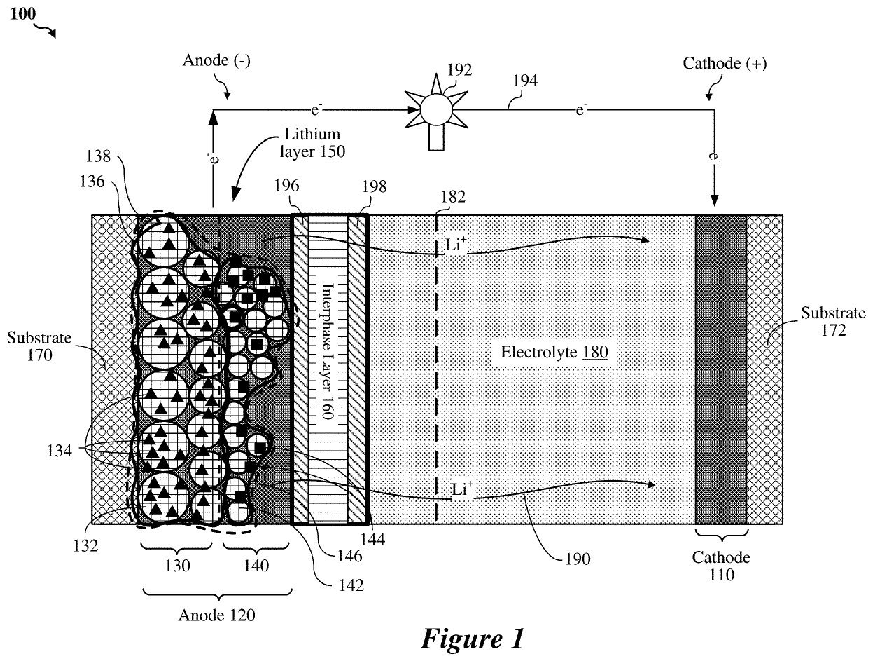

FIG. 1 shows an example battery 100, according to some implementations. The battery 100 may be an electrochemical cell, a lithium-ion battery, or a lithium-sulfur battery. The battery 100 may include a cathode 110, an anode 120, a first substrate 170, a second substrate 172, a lithium layer 150, and an electrolyte 180. In some aspects, the first substrate 170 may function as a current collector for the anode 120, and the second substrate 172 may function as a current collector for the cathode 110. In some aspects, the anode 120 may be positioned opposite to the cathode 110. The anode 120 may include a first thin film 130 deposited onto the first substrate 170, and may include a second thin film 140 deposited onto the first thin film 130. In some implementations, the electrolyte may be 180 be a liquid-phase electrolyte including one or more additives such as lithium nitrate, tin fluoride, lithium iodide, lithium bis(oxalate)borate (LiBOB), and/or the like. Suitable solvent packages for these example additives may include various dilution ratios, including 1:1:1, of 1,3-dioxolane (DOL), 1,2-dimethoxyethane, (DME), tetraethylene glycol dimethyl ether (TEGDME), and/or the like. The lithium layer 150 may be electrodeposited on one or more surfaces of the first thin film 130 and/or the second thin film 140. In some instances, the lithium layer 150 may include elemental lithium provided by the ex-situ lithium electrodeposition onto exposed surfaces of the anode 120. In addition, or in the alternative, the lithium layer 150 may include lithium, calcium potassium, magnesium, sodium, and/or cesium, where each metal may be ex-situ deposited onto the first and second thin films 130 and 140 of the anode 120.

In some implementations, the battery 100 may include a solid-electrolyte interphase layer 160. The solid-electrolyte interphase layer 160 may, in some instances, be formed artificially on the anode 120 during operational cycling of the battery 100. In such instances, the solid-electrolyte interphase layer 160 may also be referred to as an artificial solid-electrolyte interphase, or A-SEI. The solid-electrolyte interphase layer 160, when formed as an A-SEI, may include tin, manganese, molybdenum, and/or fluorine compounds. The molybdenum may provide cations, and the fluorine compounds may provide anions. The cations and anions may produce salts such as tin fluoride, manganese fluoride, silicon nitride, lithium nitride, lithium nitrate, lithium phosphate, manganese oxide, lithium lanthanum zirconium oxide (LLZO, Li₇La₃Zr₂O₁₂), etc. In some instances, the A-SEI may be formed in response to exposure of lithium ions to the electrolyte 180, which may include solvent-based solution including tin and/or fluorine.

In some implementations, the battery 100 may include a barrier layer 196. The barrier layer 196 may include a mechanical strength enhancer 198 coated and/or deposited on the anode 120. In some aspects, the mechanical strength enhancer 198 may provide structural support for the battery 100, may prevent lithium dendrite formation from the anode 120, and/or may prevent dispersion of lithium dendrite throughout the battery 100. In some implementations, the mechanical strength enhancer 198 may be formed as a protective coating over the anode 120, and may include one or more carbon allotropes, carbon nano-onions (CNOs), nanotubes (CNTs), reduced graphene oxide, graphene oxide (GO), and/or carbon nano-diamonds. In some instances, the solid-electrolyte interphase layer 160 may be formed within the mechanical strength enhancer 198.

In implementations for which the lithium layer 150 includes elemental lithium, the elemental lithium may dissociate and/or separate into lithium ions 190 and electrons 194 during the discharge cycle of the battery 100. The lithium ions 190 may move through the electrolyte 180 to their electrochemically favored positions within the cathode 110, as depicted in the example of FIG. 1. As the lithium ions 190 move through the electrolyte 180, electrons 194 are released from the elemental lithium provided by the lithium layer 150. As a result, the electrons 194 may travel from the anode 120 to the cathode 110 through a circuit to power a load 192. The load 192 may be any suitable circuit, device, or system such as (but not limited to) a lightbulb, consumer electronics, or an electric vehicle (EV).

In the example of FIG. 1, the first thin film 130 of the anode 120 may include a first plurality of aggregates 132. At least some of the first plurality of aggregates 132 may join together to form a first porous structure 136 having a first electrical conductivity. In some instances, the first electrical conductivity may be between approximately 0 and 500 S/m. In other instances, the first electrical conductivity may be between approximately 500 and 1,000 S/m. In some other instances, the first electrical conductivity may be greater than 1,000 S/m. In some aspects, the first plurality of aggregates 132 may include carbon nano-tubes (CNTs), carbon nano-onions (CNOs), flaky graphene, crinkled graphene, graphene grown on carbonaceous materials, and/or graphene grown on graphene.

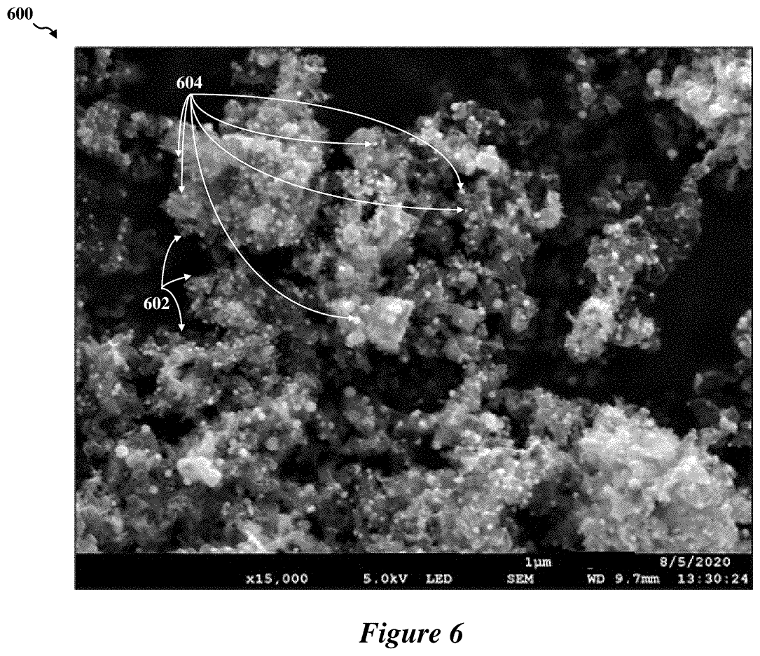

In some implementations, the first plurality of aggregates 132 may be decorated with a first plurality of metal nanoparticles 134. In some instances, the first plurality of metal nanoparticles 134 may include tin, lithium alloy, iron, silver, cobalt, semiconducting materials and/or metals such as silicon and/or the like. In some aspects, CNTs, due to their ability to provide high exposed surface areas per unit volume and stability at relatively high temperatures (such as above 77° F. or 25° C.), may be used as a support material for the first plurality of metal nanoparticles 134. For example, the first plurality of metal nanoparticles 134 may be immobilized (such as by decoration, deposition, surface functionalization or the like) onto exposed surfaces of CNTs and/or other carbonaceous materials. The first plurality of metal nanoparticles 134 may react with chemically available carbon on exposed surfaces of the CNTs and/or other carbonaceous materials, for example, as shown by the cobalt-decorated carbon-growths depicted in FIG. 6.

The second thin film 140 of the anode 120 may include a second plurality of aggregates 142. At least some of the second plurality of aggregates 142 may join together to form a second porous structure 146 having a second electrical conductivity. In some instances, the first electrical conductivity of the first porous structure 136 and/or the second electrical conductivity of the second porous structure 146 may be between approximately 0 S/m and 250 S/m. In instances for which the first porous structure 136 includes a higher concentration of aggregates than the second porous structure 146, the first porous structure 136 may have a higher electrical conductivity than the second porous structure 146. In one implementation, the first electrical conductivity may be between approximately 250 S/m and 500 S/m, while the second electrical conductivity may be between approximately 100 S/m and 250 S/m. In another implementation, the second electrical conductivity may be between approximately 250 S/m and 500 S/m. In yet another implementation, the second electrical conductivity may be greater than 500 S/m. In some aspects, the second plurality of aggregates 142 may include CNTs, CNOs, flaky graphene, crinkled graphene, graphene grown on carbonaceous materials, and/or graphene grown on graphene.

The second plurality of aggregates 142 may be decorated with a second plurality of metal nanoparticles 144. In some implementations, the second plurality of metal nanoparticles 144 may include iron, silver, cobalt, semiconducting materials and/or metals such as silicon and/or the like. In some instances, CNTs may also be used as a support material for the second plurality of metal nanoparticles 144. For example, the second plurality of metal nanoparticles 144 may be immobilized (such as by decoration, deposition, surface functionalization or the like) onto exposed surfaces of CNTs and/or other carbonaceous materials. The second plurality of metal nanoparticles 144 may react with chemically available carbon on exposed surfaces of the CNTs and/or other carbonaceous materials, for example, as shown by the cobalt-decorated carbon-growths depicted in FIG. 6.

In various implementations, each aggregate of the first plurality of aggregates 132 and/or the second plurality of aggregates 142 may be a relatively large particle formed by a plurality of relatively small particles bonded or fused together. As a result, the external surface area of the relatively large particle may be significantly smaller than combined surface areas of the plurality of relatively small particles. The forces holding an aggregate together may be, for example, covalent, ionic bonds, or other types of chemical bonds resulting from the sintering or complex physical entanglement of former primary particles.

As discussed above, the first plurality of aggregates 132 may join together to form the first porous structure 136, and the second plurality of aggregates 142 may join together to form the second porous structure 146. The electrical conductivity of the first porous structure 136 may be associated with the concentration level of the first plurality of aggregates 132, and the electrical conductivity of the second porous structure 146 may be associated with the concentration level of the second plurality of aggregates 142. For example, the concentration level of the first plurality of aggregates 132 may cause the first porous structure 136 to have a relatively high electrical conductivity, and the concentration level of the second plurality of aggregates 142 may cause the second porous structure 146 to have a relatively low electrical conductivity (e.g., such that the first porous structure 136 has a greater electrical conductivity than the second porous structure 146). The resulting differences in electrical conductivities of the first and second porous structures 136 and 146 may create an electrical conductivity gradient across the anode 120. In some implementations, the electrical conductivity gradient may be used to control or adjust electrical conduction throughout the anode 120.

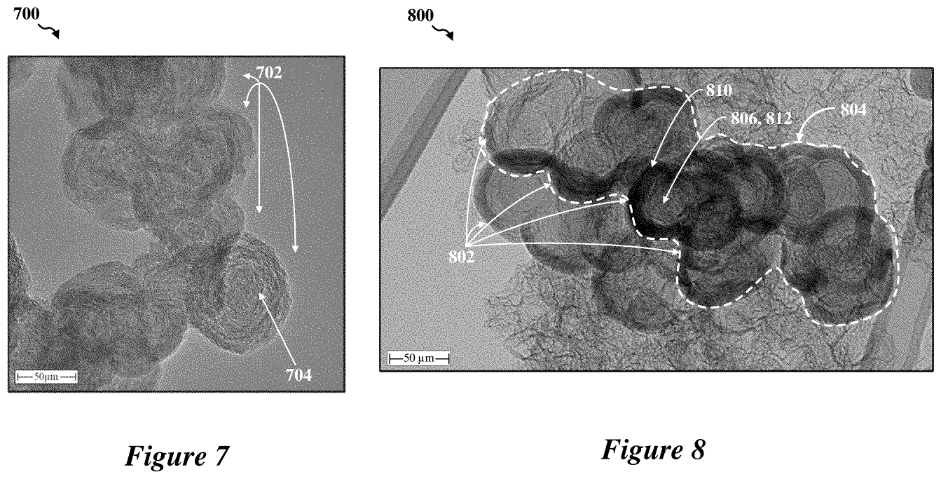

As used herein, aggregates may be referred to as “secondary particles,” and the original source particles may be referred to as “primary particles.” As shown in FIG. 1, FIG. 6, FIG. 7 and elsewhere throughout the present disclosure, the primary particles may be or include multiple graphene sheets, layers and/or nanoplatelets fused and/or joined together. Thus, in some instances, carbon nano-onions (CNOs), carbon nano-tubes (CNTs), and/or other tunable structure carbon materials may be used to form the primary particles. In some aspects, some aggregates may have a principal dimension (such as a length, a width, and/or a diameter) between approximately 500 nm and 25 μm. Also, some aggregates may include innately-formed smaller collections of primary particles, referred to as “innate particles,” of graphene sheets, layers and/or nanoplatelets joined together at orthogonal angles. In some instances, these innate particles may each have a respective dimension between approximately 50 nm and 250 nm.

The surface area and/or porosity of these innate particles may be imparted by secondary processes, such as carbon-activation by thermal processes, carbon dioxide (CO₂) treatment, and/or hydrogen gas (H₂) treatment. In some implementations, the first porous structure 136 and/or the second porous structure 146 may be derived from a carbon-containing gaseous species that can be controlled by a plurality of gas-solid reactions under non-equilibrium conditions. Deriving the first porous structure 136 and/or the second porous structure 146 in this manner may involve recombination of carbon-containing radicals formed from the controlled cooling of carbon-containing plasma species (which can be generated by excitement or compaction of feedstock carbon-containing gaseous and/or plasma species in a suitable chemical reactor).

In some implementations, the first plurality of aggregates 132 and/or the second plurality of aggregates 142 may have a percentage of carbon to other elements, except hydrogen, within each respective aggregate of greater than 99%. In some instances, a median size of each aggregate is between approximately 0.1 microns and 50 microns. The first plurality of aggregates 132 and/or the second plurality of aggregates 142 may also include metal organic frameworks (MOFs).

In some aspects, the first thin film 130 and/or the second thin film 140 (as well as any additional thin films disposed on their respective immediately preceding thin film) may be defined as a layer of material and/or aggregates. The layer may range from fractions of a nanometer (in instances of a monolayer) to several microns in thickness, such as between approximately 0 and 5 microns, between approximately 5 and 10 microns, between approximately 10 and 15 microns, or greater than 15 microns. Any of the materials and/or aggregates disclosed herein, such as CNOs, may be incorporated into the first thin film 130 and/or the second thin film 140 to result in the described thickness levels.

In some implementations, the first thin film 130 may be deposited onto the first substrate 170 by chemical deposition, physical deposition, or grown layer-by-layer through techniques such as Frank-van der Merwe growth, Stranski-Krastonov growth, Volmer-Weber growth and/or the like. In other implementations, the first thin film 130 may be deposited onto the first substrate 170 by epitaxy or other suitable thin-film deposition process involving the epitaxial growth of materials. The second thin film 140 and/or subsequent thin films may be deposited onto their respective immediately preceding thin film in a manner similar to that described with reference to the first thin film 130.

In some implementations, the first porous structure 136 and second porous structure 146 may collectively define a host structure 138, for example, as shown in FIG. 1. In some instances, the host structure 138 may be based on a carbon scaffold and/or may include decorated carbons, for example, as shown in FIG. 6. The host structure 138 may provide structural definition to the anode 120. In the example shown in FIG. 1, the host structure 138 may be fabricated as a negative electrode and used in the anode 120. In other implementations, the host structure 138 may be fabricated as a positive electrode and used in the cathode 110. In some instances, the host structure 138 may include pores having specifically defined sizes, such as micro, meso, and/or macro pores according to IUPAC definitions, with at least some micropores sized at approximately 1.5 nm in width for pre-loading of sulfur and/or to temporarily microconfine polysulfides (PS) that may be generated during operational cycling.

The host structure 138, when provided within the anode 120 as shown in FIG. 1, may include micro, meso, and/or macro porous pathways defined by exposed surfaces and/or contours of the first porous structure 136 and/or the second porous structure 146. These pathways may allow the host structure 138 to receive the electrolyte 180, for example, by transporting lithium ions towards the cathode 110. The electrolyte 180 may infiltrate the various porous pathways of the host structure 138 and uniformly disperse throughout the anode 120 and/or other portions of the battery 100.

In some aspects, each of the first porous structure 136 and/or the second porous structure 146 may have a porosity defined by one or more of a thermal process, a carbon dioxide (CO₂) gas treatment, or a hydrogen gas (H₂) treatment. Specifically, the micro, meso, and macro porous pathways of the host structure 138 of the anode 120 may include macroporous pathways, mesoporous pathways, and/or microporous pathways, for example, in which the macroporous pathways have a principal dimension greater than 50 nm, the mesoporous pathways have a principal dimension between approximately 20 nm and 50 nm, and the microporous pathways have a principle dimension less than 4 nm. As such, the macroporous pathways and mesoporous pathways can provide tunable conduits for transporting lithium ions 190, and the microporous pathways may confine active materials within the anode 120.

In some implementations, the anode 120 may include more than two thin films such as one or more additional thin films. Each of the one or more additional thin films may include individual aggregates interconnected with each other across different thin films, with at least some of the thin films having different concentration levels of aggregates. As a result, the concentration levels of any thin film may be varied (such as by gradation) to achieve particular electrical resistance (or conductance) values. For example, in some implementations, the concentration levels of aggregates may progressively decline between the first thin film 130 and the last thin film (such as in a direction from the first substrate 170 to the second substrate 172) and/or the individual thin films may have an average thickness between approximately 10 microns and approximately 200 microns. In addition, or in the alternative, the first thin film 130 may have a relatively high concentration of carbon-based aggregates, and the second thin film 140 may have a relatively low concentration of carbon-based aggregates. In some aspects, the relatively high concentration of aggregates corresponds to a relatively low electrical resistance, and the relatively low concentration of aggregates corresponds to a relatively high electrical resistance.

The host structure 138 may be prepared with multiple active sites on exposed surfaces of the first plurality of aggregates 132 and/or the second plurality of aggregates 142. These active sites, as well as the exposed surfaces of the aggregates 132 and 142, may be prepared to undergo an ex-situ electrodeposition, such as electroplating, prior to incorporation of the anode 120 into the battery 100. Electroplating is a process that creates the lithium layer 150 (including lithium on exposed surfaces of the host structure 138) through chemical reduction of metal cations by application of a direct current. In some implementations, the host structure 138 may be electroplated such that the lithium layer 150 has a thickness between approximately 1 and 5 microns, 5 and 20 microns, or greater than 20 microns. In some instances, ex-situ electrodeposition may be performed at a location separate from the battery 100 prior to the assembly of the battery 100.

In various implementations, excess lithium provided by the lithium layer 150 may increase the number of lithium ions 190 available in the battery 100, thereby increasing the storage capacity, longevity, and performance of the battery 100 (as compared with traditional lithium-ion and/or lithium-sulfur batteries).

In some aspects, the lithium layer 150 may be configured to produce lithium-intercalated graphite (LiC₆) and/or lithiated graphite based on chemical reactions with the first plurality of aggregates 132 and/or the second plurality of aggregates 142. Lithium intercalated between alternating graphene layers may migrate or be transported within the anode 120 due to differences in electrochemical gradients during operational cycling of the battery 100, which in turn may increase the energy storage and power delivery of the battery 100.

In some other implementations, each of the first substrate 170 and the second substrate 172 may be a current collector, such as a solid aluminum or copper metal foil. Accordingly, in some instances, the first substrate 170 and/or the second substrate 172 may be a solid copper metal foil. The first substrate 170 and/or the second substrate 172 may influence the capacity, rate capability and long-term stability of the battery 100. In addition, or in the alternative, the first substrate 170 and/or the second substrate 172 may undergo treatments such as etching and carbon coating to increase electrochemical stability and/or electrical conductivity.

In other implementations, the first substrate 170 and/or the second substrate 172 may include or may be formed from aluminum, copper, nickel, titanium, stainless steel and/or carbonaceous materials (such as depending on end-use applications and/or performance requirements of the battery 100). For example, the first substrate 170 and/or the second substrate 172 may be created to achieve certain defined electrochemical stability, electrical conductivity, mechanical property, density, and sustainability goals for the battery 100 and therefore function with the anode 120 and the cathode 110, respectively.

In some aspects, the first substrate 170 and/or the second substrate 172 may be at least partially foam-based or foam-derived and can be selected from any one or more of metal foam, metal web, metal screen, perforated metal, or a sheet-based 3D structure. In other aspects, the first substrate 170 and/or the second substrate 172 may be a metal fiber mat, metal nanowire mat, conductive polymer nanofiber mat, conductive polymer foam, conductive polymer-coated fiber foam, carbon foam, graphite foam, or carbon aerogel. In some other aspects, the first substrate 170 and/or second substrate 172 may be carbon xerogel, graphene foam, graphene oxide foam, reduced graphene oxide foam, carbon fiber foam, graphite fiber foam, exfoliated graphite foam, or combinations thereof.

In some implementations, the host structure 138 may include or at least temporarily confine an insulating material. The insulating material may include any one or more of nanodiscs, nanoplatelets, nano-fullerenes, carbon nano-onions (CNOs), nano-coating, or nanosheets of an inorganic material. The inorganic material may include bismuth selenide, bismuth telluride, a transition metal dichalcogenide or trichalcogenide, sulfide, selenide, a telluride of a transition metal, boron nitride, or any combination thereof. In some aspects, the nanodiscs, nanoplatelets, nano-coating, or nano sheets may have a thickness less than 100 nm. In other examples, the nanoplatelets can have a thickness less than 10 nm, and/or can have a length, width, or diameter less than 5 microns.

In various implementations, the solid-electrolyte interphase layer 160 may be provided on the anode 120 during the first few charge-discharge cycles of the battery 100. In some instances, the solid-electrolyte interphase layer 160 may provide a passivation layer including an outer layer of shield material that can be applied to the anode 120 as a micro-coating. In this way, formation of the solid-electrolyte interphase layer 160 on the anode 120 in a direction of the electrolyte 180 may inhibit decomposition of the electrolyte 180.

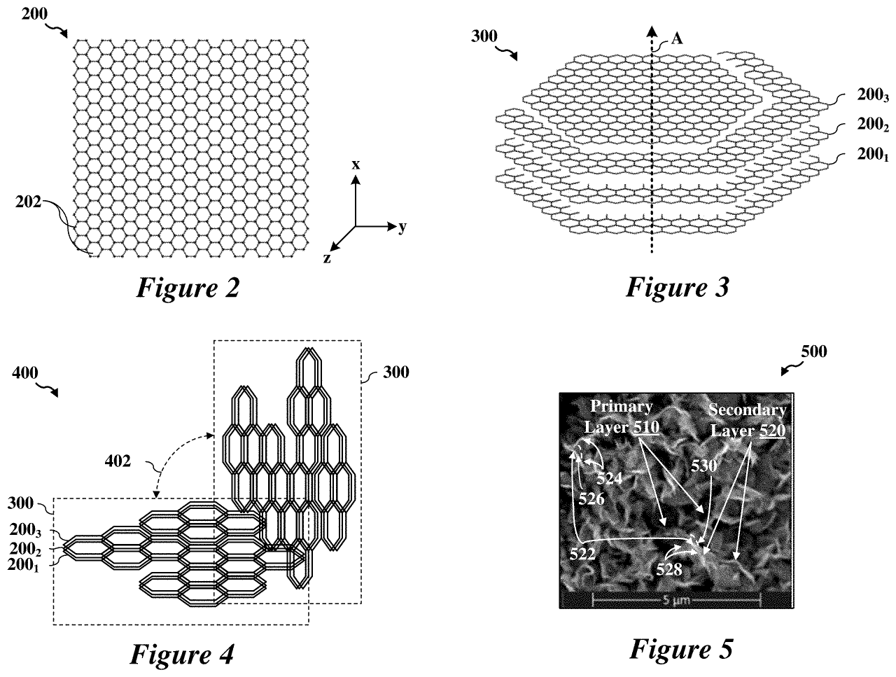

FIG. 2 shows an example graphene 200, according to some implementations. The graphene 200 may include a single layer of carbon atoms with each atom bound to three neighbors in a honeycomb structure. In some aspects, the single layer may be a discrete material restricted in one dimension, such as within or at a surface of a condensed phase. For example, the graphene 200 may grow outwardly only in the x and y planes (and not in the z plane). In some aspects, the graphene 200 may be a two-dimensional (2D) material, including one or several layers with the atoms in each layer strongly bonded (such as by a plurality of carbon-carbon bonds 202) to neighboring atoms in the same layer.

In some instances, the graphene 200 may be stacked on top of itself to form a bulk material, such as graphite including multiple discrete graphene stacked parallel to each other in a three dimensional, crystalline, long-range order. The number of discrete graphene in the resulting bulk material may depend one or more properties of the material. In the case of layers of the graphene 200, each layer of the graphene 200 may be a 2D material including up to 10 layers. In some implementations, the graphene 200 shown in FIG. 2 may join together with other instances of the graphene 200 in a suitable chemical reactor to form other carbon structures. These materials may be used as building blocks to form any of the first aggregates 132 and/or the second aggregates 142 of FIG. 1.

FIG. 3 shows an example of a graphene nanoplatelet 300, according to some implementations. In some instances, the graphene nanoplatelet 300 may include multiple instances of the graphene 200 of FIG. 2, such as a first graphene layer 200₁, a second graphene layer 200₂, and a third graphene layer 200₃, all stacked on top of each other in a vertical direction denoted by arrow A in FIG. 3. The graphene nanoplatelet 300, which may be referred to as a GNP, may have a thickness between 1 nm and 3 nm, and may have lateral dimensions ranging from approximately 100 nm to 100 μm. In some implementations, the graphene nanoplatelet 200 may be produced by multiple plasma spray torches arranged sequentially by roll-to-roll (R2R) production. In some aspects, R2R production may include deposition upon a continuous substrate that is processed as a rolled sheet, including transfer of 2D material(s) to a separate substrate. In some instances, the R2R production may be used to form the first thin film 130 and/or the second thin film 140, for example, each having different concentration levels of the first plurality of aggregates 132 and the second plurality of aggregates 142. That is, the plasma spray torches used in the R2R processes may spray carbonaceous materials at different concentration levels to create the first thin film 130 and/or the second thin film 140 using specific concentration levels of graphene nanoplatelets 300. Therefore, R2R processes may provide for a fine level of tunability for the battery 100.

FIG. 4 shows several graphene nanoplatelets 300 of FIG. 3 joined together to form an aggregate 400, according to some implementations. The graphene nanoplatelets 300 used to form the aggregate 400 may be joined together at an angle 402. In some aspects, the angle 402 may be orthogonal, such as approximately 90 degrees relative from an initial instance of the graphene nanoplatelet 300 to a subsequent instance of the graphene nanoplatelet 300. The angle 402 at which various instances of the graphene nanoplatelet 300 join together may be defined during synthesis of the aggregate 400 and/or the graphene nanoplatelet 300 within, for example, a reactor.

FIG. 5 is a micrograph 500 showing carbonaceous materials suitable for use in the anode 120 of FIG. 1, according to some implementations. The micrograph 500 shows a primary layer 510 and a secondary layer 520, each including and/or being formed from various instances of the graphene 200 of FIG. 2 joined together to form larger structures. Such larger structures may, for example, include various instances of the graphene nanoplatelet 300 and/or the aggregate 400. In some implementations, a 3D innate carbon-based growth may include the primary layer 510. In some instances, the primary layer 510 may be formed from interconnected instances of the aggregate 400 of FIG. 4 and/or any aggregate of the first plurality of aggregates 132 and/or the second plurality of aggregates 142.

The secondary layer 520 may be disposed on the primary layer 510, and may include a non-concentric co-planar junction 522. In some aspects, the non-concentric co-planar junction 522 may include a first layer of platelets 524 joined together. Each platelet 524 may be, for example, the graphene nanoplatelet 300 and/or the aggregate 400, and may have similar dimensionality to adjacent platelets connected together (such as to form the first layer of platelets 524) at respective non-concentration co-planar junctions 522. Each platelet of the first layer of platelets 524 may be oriented to other platelets at a first angle 526. In addition, a second layer of platelets 528 may extend from the first layer of platelets 524 at respective non-concentric co-planar junctions 522 at a second angle 530. In some aspects, the second angle 530 may be different than the first angle 526. In addition, or in the alternative, the primary layer 510 may be rotated relative to the secondary layer 520 by approximately 90 degrees.

FIG. 6 is a micrograph 600 of a carbon-based scaffold 602, according to some implementations. The carbon-based scaffold 602 may be incorporated in any of the carbonaceous structures described in the present disclosure. In some aspects, the carbon-based scaffold 602 may be decorated with a plurality of cobalt nanoparticles 604. The carbon-based scaffold 602 may be constructed from growths of the carbonaceous materials shown in the micrograph 500 of FIG. 5, such as the primary layer 510 and/or the secondary layer 520. In contrast to a 2D graphene material, the carbon-based scaffold 602 has a convoluted 3D structure that can prevent graphene restacking, thereby avoiding drawbacks of only using 2D graphene layers as a formative material. This process also increases the areal density of the materials, yielding higher electroactive (such as lithium) material adsorption and/or reaction (such as intercalation to form lithiated graphite) sites per unit area, thereby improving the specific capacity of the host structure 138 of the anode 120 of the battery 100 shown in FIG. 1.

The carbon-based scaffold 602 shown in FIG. 6 may be produced using flow-through type microwave plasma reactors configured to create pristine 3D graphene particles continuously from a hydrocarbon gas at near atmospheric pressures. Operationally, as the hydrocarbon flows through a relatively hot zone of a plasma reactor, free carbon radicals may be formed that flow further down the length of the reactor into the growth zone where 3D carbon particulates (based on multiple 2D graphenes joined together) are formed and collected as fine powders. The density and composition of the free-radical carbon-inclusive gaseous species may be tuned by gas chemistry and microwave power levels. By controlling the reactor process parameters, these reactors may produce carbons with a wide, yet tunable, range of physical characteristics, such as shape, crystalline order, and sizes (and distributions). For example, possible sizes and distributions may range from flakes (from a few 100 nm to one or more microns in width and a few nm in thickness) to spherical particles (such as having a diameter between approximately 10 nm and 100 nm) to graphene clusters (such as having a diameter between approximately 10 and 100 microns). The 3D nature of the materials prevents agglomeration in certain circumstances, thereby effectively allowing for the materials to be disseminated as un-agglomerated particles. As a result, highly convoluted materials having a high exposed surface area per unit volume can be produced. Graphene, an atomically 2D material, has many advantageous properties for sensing, including outstanding chemical and mechanical strength, high carrier mobility, high electrical conductivity, high surface area, and gate-tunable carrier density.

In some aspects, the carbon-based scaffold 602 may include CNO oxides organized as a monolithic and/or interconnected growth and be produced in a thermal reactor. The carbon-based scaffold 602 may be decorated with cobalt nanoparticles 604 according to the following example recipe: cobalt(II) acetate (C₄H₆CoO₄), the cobalt salt of acetic acid (often found as tetrahydrate Co(CH₃CO₂)₂·4 H₂O, which may be abbreviated as Co(OAc)₂·4 H₂O, may be flowed into the thermal reactor at a ratio of approximately 59.60 wt % corresponding to 40.40 wt % carbon (referring to carbon in CNO form), resulting in the functionalization of active sites on the CNO oxides with cobalt, showing cobalt-decorated CNOs at a 15,000× level, respectively. In some implementations, suitable gas mixtures used to produce Carbon #29 and/or the cobalt-decorated CNOs may include the following steps:
Ar purge 0.75 standard cubic feet per minute (scfm) for 30 min;
Ar purge changed to 0.25 scfm for run;
temperature increase: 25° C. to 300° C. 20 mins; and
temperature increase: 300°-500° C. 15 mins.

FIG. 7 shows a micrograph 700 of a plurality of CNOS 702, according to some implementations. In various implementations, each CNO 702 may have a core region 704 with a defined of carbon growth and/or layering. In some instances, the CNOs 702 may be multi-layered fullerenes. The shape, size, and layer count, such as layers of the graphene 200 of FIG. 2, may depend on manufacturing processes. The plurality of CNOs 702 may, in some aspects, demonstrate poor water solubility. As such, in some implementations, non-covalent functionalization may be utilized to alter one or more dispersibility properties of the plurality of CNOs 702 without affecting the intrinsic properties of formative sp² carbon nanomaterial in each CNO 702. In some aspects, the plurality of CNOs 702 may be grown from the aggregate 400 of FIG. 4 and/or may form the first plurality of aggregates 132 and/or the second plurality of aggregates 142. Each CNO 702 may have a diameter between approximately 50 and 75 microns.

FIG. 8 shows a micrograph 800 of an aggregate 804 formed from joining several CNOs of a plurality of CNOs 802 together, according to some implementations. For example, exterior carbon-containing shell-type layers of each CNO 802 may fuse together with carbons provided by other carbon-containing shell-type layers of other CNOs 802 to form an aggregate 804. In some aspects, a core region 806 of each of the CNOs 802 may be tunable. For example, the core region 806 may have a defined concentration level of interconnected graphenes, such as multiple instances of the graphene 200 of FIG. 2. As a result, some of the plurality of CNOs 802 may have a first concentration 810 of interconnected carbons approximately between 0.1 g/cc and 2.3 g/cc at or near a shell of the respective CNO 802. Each of the CNOs 802 may have a plurality of pores configured to transport lithium ions extending inwardly from the first concentration 810 toward and/or from the core region 806.

In some implementations, each pore may have a width or dimension between approximately 0.0 nm and 0.5 nm, between approximately 0.0 and 0.1 nm, between approximately 0.0 and 6.0 nm, or between approximately 0.0 and 35 nm. Each CNO of the plurality of CNOs 802 may also have a second concentration 812 at the core region 806 of interconnected carbons. The second concentration 812 may include a plurality of relatively lower-density regions arranged concentrically. The second concentration 812 may be between approximately 0.0 g/cc and 1.0 g/cc or between approximately 1.0 g/cc and 1.5 g/cc. The relationship between the first concentration 810 and the second concentration 812 may increase the ability to enclose and/or confine sulfur or lithium polysulfides (PS). For example, sulfur and/or lithium polysulfides may travel through the first concentration 810 and be at least temporarily confined within and/or interspersed throughout the second concentration 812 during operational cycling of a lithium-sulfur battery.

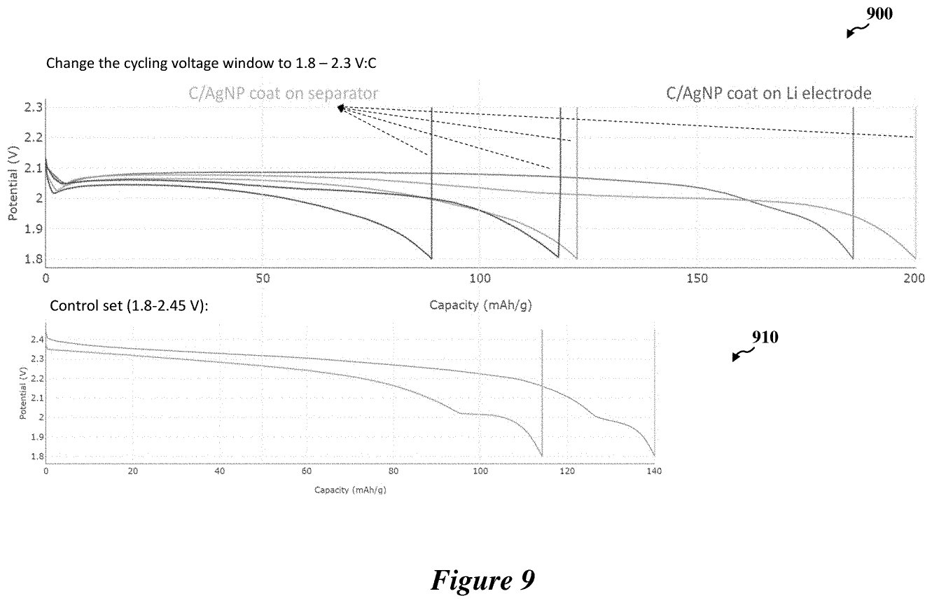

FIG. 9 shows first and second graphs 900 and 910 depicting performance of lithium-sulfur electrochemical cells with carbon-silver nanoparticle composite coated components, according to some implementations. For example, the first graph 900 shows performance of the battery 100 of FIG. 1 over a cycling voltage window of approximately 1.8 V-2.3 V. Over this cycling window, silver decorated carbon nanoparticles coated onto the separator 182 of the battery 100 of FIG. 1 may increase the specific capacity (measured in mAh/g) of the battery 100. Moreover, silver nanoparticles decorating a carbon scaffolded electrode, such as the anode 120 defined by the host structure 138 of FIG. 1, may further increase performance of the battery 100 when combined with other coatings applied to the separator 182. In some aspects, the battery 100 may operate with a voltage window between approximately 1.8 V and 2.3 V, as higher voltage levels may lead to undesirable and/or severe self-discharging resulting from uncontrolled migration of lithium ions 190 and/or polysulfides throughout the battery 100.

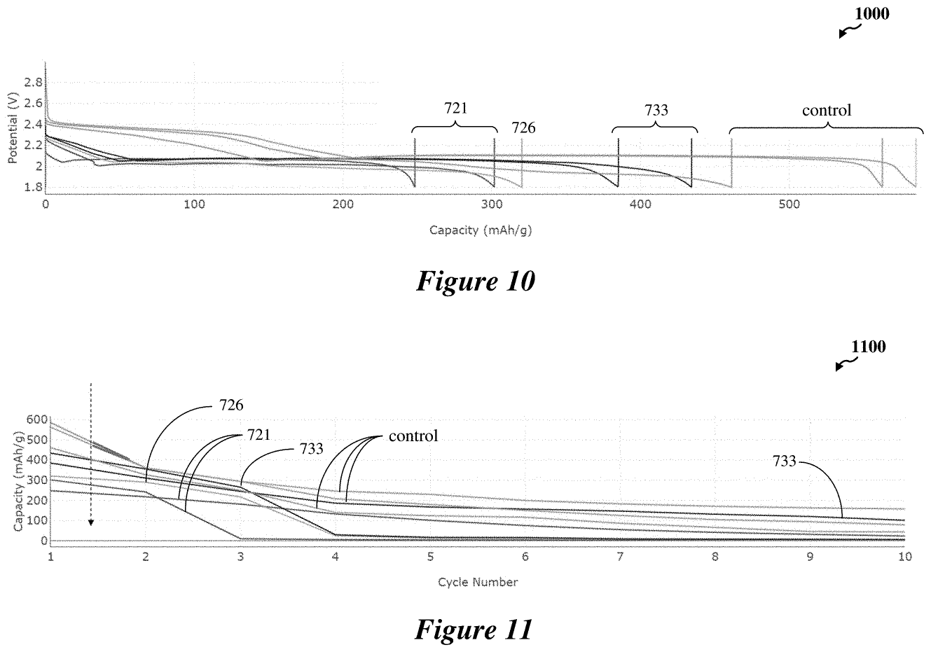

FIGS. 10 and 11 show first and second graphs 1000 and 1100 depicting performance of lithium-sulfur electrochemical cells, according to some implementations. For example, in some instances, the battery 100 may be prepared with the separator 182 including a carbon nano-onion (CNO) metal nanoparticle coating. In such configurations, the electrolyte 180 may include and/or consist of 1 M lithium bis(trifluoromethanesulfonyl)imide (LiC₂F₆NO₄S₂, LiTFSI) in DME/DOL/TEGDME (volume:volume:volume=1:1:1). In some aspects, numerical identifiers such as “721,” “726,” and/or “733” may be assigned as shown to differentiate test operational cycling of the battery 100 from the control cycling of the battery 100. As shown in the first graph 1000, these operational cycles may include the addition of CNOs and/or metal nanoparticles decorated onto CNOs above certain predefined threshold levels (such as above levels shown in FIG. 6). This may increase the internal cell impedance of the battery 100, which in turn may undesirably reduce the mean discharge voltage in lithium-sulfur systems. As such, the addition of silver or tin nanoparticles may not be suitable in lithium-sulfurs systems due to the formation and presence of migratory long-chain polysulfides.

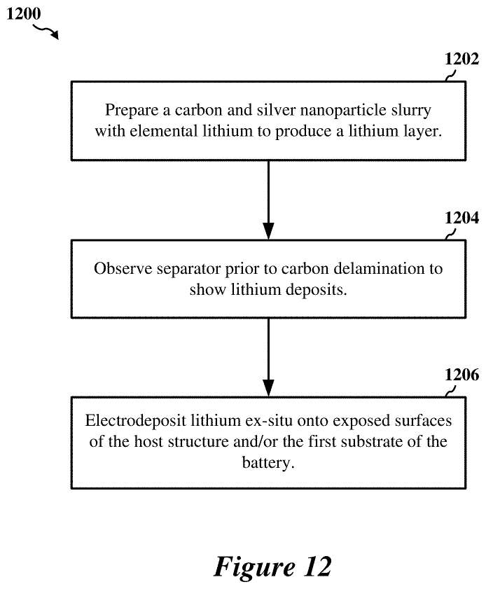

FIG. 12 shows an example process 1200 for lithium electrodeposition on a carbon-silver nanoparticle (NP) composite, according to some implementations. As described earlier, the battery 100 may include a lithium layer 150 provided by an ex-situ electrodeposition operation. At block 1202, a carbon and silver nanoparticle slurry (such as containing the plurality of CNOs 802 forming the aggregate 804 of FIG. 8) may be prepared with elemental lithium to produce the lithium layer 150 of the host structure 138. In some implementations, the electrodeposition may be performed for approximately 20 hours (hrs.) at 0.12 mA/cm² to produce a lithium layer having a thickness of approximately 40 microns. At block 1204, a separator 182 may be observed prior to carbon delamination to show lithium deposits (such as deposited by lithium in the electrolyte 180 and/or ex-situ electrodeposition procedures as discussed for FIG. 1). At block 1206, lithium is electrodeposited, ex-situ, onto exposed surfaces of the host structure 138 and/or the first substrate 170.

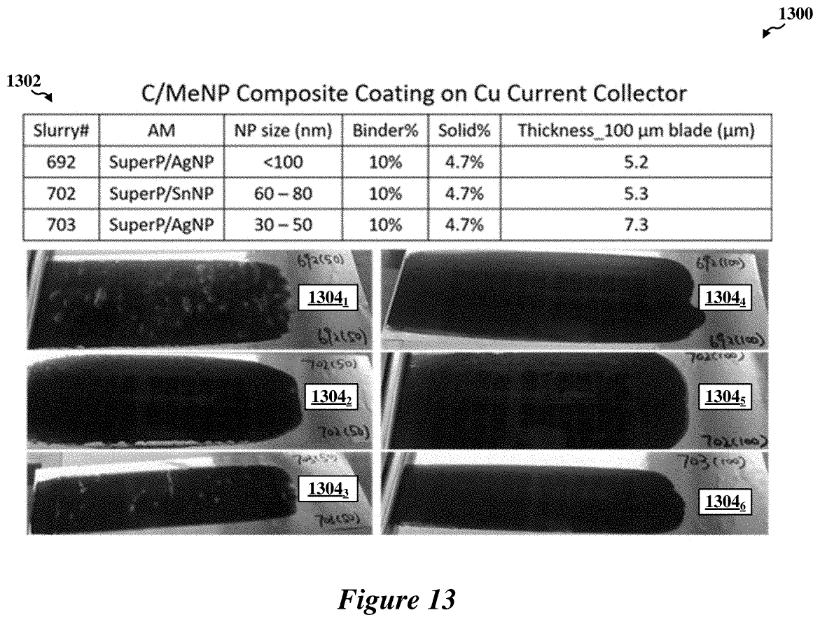

FIG. 13 is an illustration 1300 of ex-situ lithium electrodeposition onto a carbon-metal nanoparticle (NP) for various substrate materials, according to some implementations. The illustration 1300 includes a table 1302 listing various aggregate material (AM) names, such as “SuperP” (referring to the aggregate 400 and/or the first plurality of aggregates 132 and/or the second plurality of aggregates 142) and/or silver or tin particles decorated onto the carbons, similar to that shown in the micrograph 600 in FIG. 6. Nanoparticle (NP) sizes may be varied, as well as inclusion of binder and carbon black (solid %), to general overall layer thicknesses in the ranges shown, such as at approximately 5.2 μm, 5.3 μm, and 7.3 μm. Experimental trials are also shown. For example, a first experimental trial 1304₁, a second experimental trial 1304₂, a third experimental trial 1304₃, a fourth experimental trial 1304₄, a fifth experimental trial 1304₅, and a sixth experimental trial 1304₆ all may show variations of the lithium layer 150 as achieved in real-life settings, including laboratory and/or industrial-scale settings.

As used herein, a phrase referring to “at least one of” or “one or more of” a list of items refers to any combination of those items, including single members. For example, “at least one of: a, b, or c” is intended to cover the possibilities of: a only, b only, c only, a combination of a and b, a combination of a and c, a combination of b and c, and a combination of a and b and c.

The various illustrative components, logic, logical blocks, modules, circuits, operations, and algorithm processes described in connection with the implementations disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the application and design constraints imposed on the overall system.

Various modifications to the implementations described in this disclosure may be readily apparent to persons having ordinary skill in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described above in combination with one another, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single product or packaged into multiple products.

What is claimed is:

1. A battery comprising:
a cathode;
an anode positioned opposite the cathode, the anode comprising:
a first thin film deposited on a current collector, the first thin film including a first plurality of aggregates decorated with a first plurality of metal nanoparticles and joined together to define a first porous structure having a first conductivity; and
a second thin film deposited on the first thin film, the second thin film including a second plurality of aggregates decorated with a second plurality of metal nanoparticles and joined together to define a second porous structure having a second conductivity that is different than the first conductivity; and
a lithium layer deposited on the first and second porous structures, the lithium layer having a thickness greater than 20 microns.

2. The battery of claim 1, wherein the lithium layer is configured to produce lithium-intercalated graphite (LiC₆) based on chemical reactions with any one or more of the first plurality of aggregates or the second plurality of aggregates.

3. The battery of claim 1, wherein at least one of the first porous structure or the second porous structure includes any one or more of carbon nano-onions (CNOs), flaky graphene, crinkled graphene, graphene grown on carbonaceous materials, or graphene grown on graphene.

4. The battery of claim 1, wherein the lithium layer includes an excess supply of lithium configured to compensate for an operational cycle loss of the battery.

5. The battery of claim 1, wherein the lithium layer comprises an elemental lithium electrodeposition.

6. The battery of claim 5, wherein the elemental lithium electrodeposition includes trace quantities of one or more additives.

7. The battery of claim 1, further comprising an electrolyte containing a carbonate and in contact with the cathode and the lithium layer.

8. The battery of claim 1, further comprising an electrolyte containing ether and in contact with the cathode and the lithium layer.

9. The battery of claim 1, wherein the first and second porous structures are based on a gaseous species.

10. The battery of claim 9, wherein the gaseous species is associated with a plurality of gas-solid reactions under non-equilibrium conditions.

11. The battery of claim 1, wherein the first plurality of aggregates and the second plurality of aggregates have a percentage of carbon to other elements, except hydrogen, within each respective aggregate of greater than 99%.

12. The battery of claim 1, wherein a median size of each aggregate is between approximately 0.1 microns and 50 microns.

13. The battery of claim 1, wherein a surface area of the aggregates is between approximately 10 m²/g and 300 m²/g.

14. The battery of claim 1, wherein the first and second porous structures have a porosity defined by one or more of a thermal process, a carbon dioxide (CO₂) gas treatment, or a hydrogen gas (H₂) treatment.

15. The battery of claim 1, wherein the first and second pluralities of metal nanoparticles include tin (Sn) or a Li alloy.

16. The battery of claim 1, wherein the first and second pluralities of aggregates include one or more metal-organic frameworks (MOFs).

17. The battery of claim 1, wherein the first and second pluralities of aggregates include one or more of lithium, calcium, potassium, sodium, or cesium.

18. The battery of claim 1, further comprising an electrolyte contained within the battery and in contact with the anode and the cathode.

19. The battery of claim 18, wherein the electrolyte is configured to transport lithium ions towards the cathode.

20. The battery of claim 18, further comprising an artificial solid electrolyte interphase (A-SEI) disposed between the anode and the electrolyte.

21. The battery of claim 20, wherein the A-SEI is formed on one or both of the first and second pluralities of metal nanoparticles.

22. The battery of claim 1, wherein the battery is a lithium-ion battery.

23. The battery of claim 1, wherein the battery is a lithium-sulfur battery.

24. The battery of claim 1, wherein the first conductivity is greater than the second conductivity.

25. The battery of claim 1, wherein the first thin film has a different concentration of aggregates than the second thin film.

26. The battery of claim 1, wherein the first thin film has a higher concentration of aggregates than the second thin film.

27. The battery of claim 1, wherein each aggregate of the first and second pluralities of aggregates has an electrical conductivity greater than 500 Siemens per meter (S/m).

28. The battery of claim 1, further comprising a separator positioned between the anode and the cathode.

29. The battery of claim 1, wherein the first and second thin films have an average thickness between approximately 10 microns and approximately 200 microns.

30. The battery of claim 1, further comprising a third thin film deposited on the second thin film, the third thin film including a third plurality of aggregates joined together to define a third porous structure having a third conductivity that is different than the first conductivity and the second conductivity.

31. The battery of claim 1, wherein each of first and second porous structures includes a plurality of interconnected channels.

32. The battery of claim 31, wherein each of the interconnected channels comprises a first portion configured to provide a Li ion conduit and a second portion configured to facilitate rapid Li ion transport.
